(19) United States
(12) Patent Application Publication
(10) Pub. No.: US 2025/0021406 A1
(43) Pub. Date: Jan. 16, 2025

(54) Function as a Service Fusion Deployment with Polyglot Functions

(71) Applicant: Dell Products L.P., Round Rock, TX (US)

(72) Inventors: Yair Yotam, Beer Sheva (IL); Boris Shpilyuck, Ashdod (IL); Igor Dubrovsky, Beer Sheva (IL)

(21) Appl. No.: 18/352,805

(22) Filed: Jul. 14, 2023

(51) Int. Cl. G06F 9/54; G06F 8/71

(52) U.S. Cl. CPC G06F 9/54; G06F 8/71

(57) ABSTRACT

A system can determine to combine a first function that executes in a first container and a second function that executes in a second container in a third container. The system can determine a first runtime of the first function based on a first container configuration of the first container. The system can determine a second runtime of the second function based on a second container configuration of the second container. The system can deploy the third container that comprises the first function matched to the first runtime and the second function matched to the second runtime. The system can direct a first call to the first function to the third container. The system can direct a second call to the second function to the third container.

### RELATED APPLICATIONS

The subject patent application is related by subject matter to, U.S. patent application Ser. No. ______ (docket number 133261.01/DELLP873US), filed Jul. 14, 2023 and entitled “FUNCTION AS A SERVICE FUSION DEPLOYMENT,” the entirety of which application is hereby incorporated by reference herein.

The subject patent application is related by subject matter to, U.S. patent application Ser. No. ______ (docket number 134359.01/DELLP926US), filed Jul. 14, 2023 and entitled “FUNCTION AS A SERVICE FUSION DEPLOYMENT,” the entirety of which application is hereby incorporated by reference herein.

### BACKGROUND

A computer function can generally comprise a portion of computer-executable code that performs a task, and can be distinguished from a pure mathematical function.

### SUMMARY

The following presents a simplified summary of the disclosed subject matter in order to provide a basic understanding of some of the various embodiments. This summary is not an extensive overview of the various embodiments. It is intended neither to identify key or critical elements of the various embodiments nor to delineate the scope of the various embodiments. Its sole purpose is to present some concepts of the disclosure in a streamlined form as a prelude to the more detailed description that is presented later.

An example system can operate as follows. The system can determine to combine a first function that executes in a first container and a second function that executes in a second container in a third container. The system can determine a first runtime of the first function based on a first container configuration of the first container. The system can determine a second runtime of the second function based on a second container configuration of the second container. The system can deploy the third container that comprises the first function matched to the first runtime and the second function matched to the second runtime. The system can direct a first call to the first function to the third container. The system can direct a second call to the second function to the third container.

An example method can comprise determining, by a system comprising a processor, to combine a first function that executes in a first container and a second function that executes in a second container in a third container. The method can further comprise determining, by the system, a first runtime of the first function based on a first container configuration of the first container, and a second runtime of the second function based on a second container configuration of the second container. The method can further comprise deploying, by the system, the third container that comprises the first function matched to the first runtime and the second function matched to the second runtime. The method can further comprise directing, by the system, calls to the first function or to the second function to the third container.

An example non-transitory computer-readable medium can comprise instructions that, in response to execution, cause a system comprising a processor to perform operations. These operations can comprise determining a first runtime of a first function that executes in a first container based on a first container configuration of the first container, and a second runtime of a second function that executes in a second container based on a second container configuration of the second container. These operations can further comprise deploying a third container that comprises the first function matched to the first runtime and the second function matched to the second runtime. These operations can further comprise directing calls to the first function or to the second function to the third container.

### BRIEF DESCRIPTION OF THE DRAWINGS

Numerous embodiments, objects, and advantages of the present embodiments will be apparent upon consideration of the following detailed description, taken in conjunction with the accompanying drawings, in which like reference characters refer to like parts throughout, and in which:

FIG. 1 illustrates an example system architecture that can facilitate Function as a Service (FaaS) fusion deployment with polyglot functions, in accordance with an embodiment of this disclosure;

FIG. 2 illustrates an example system architecture for static function analysis that can facilitate FaaS fusion deployment with polyglot functions, in accordance with an embodiment of this disclosure;

FIG. 3 illustrates another example system architecture for static function analysis that can facilitate FaaS fusion deployment with polyglot functions, in accordance with an embodiment of this disclosure;

FIG. 4 illustrates an example system architecture for dynamic function analysis that can facilitate FaaS fusion deployment with polyglot functions, in accordance with an embodiment of this disclosure;

FIG. 5 illustrates another example system architecture for dynamic function analysis that can facilitate FaaS fusion deployment with polyglot functions, in accordance with an embodiment of this disclosure;

FIG. 6 illustrates an example process flow for dynamic function analysis that can facilitate FaaS fusion deployment with polyglot functions, in accordance with an embodiment of this disclosure;

FIG. 7 illustrates an example system architecture for merging functions that can facilitate FaaS fusion deployment with polyglot functions, in accordance with an embodiment of this disclosure;

FIG. 8 illustrates an example system architecture for merging functions polyglot functions, and that can facilitate FaaS fusion deployment with polyglot functions, in accordance with an embodiment of this disclosure;

FIG. 9 illustrates an example system architecture for using a configuration file in merging functions polyglot functions, and that can facilitate FaaS fusion deployment with polyglot functions, in accordance with an embodiment of this disclosure;

FIG. 10 illustrates another example system architecture for using a configuration file in merging functions polyglot functions, and that can facilitate FaaS fusion deployment with polyglot functions, in accordance with an embodiment of this disclosure;

FIG. 11 illustrates an example process flow that can facilitate FaaS fusion deployment with polyglot functions, in accordance with an embodiment of this disclosure;

FIG. 12 illustrates another example process flow that can facilitate FaaS fusion deployment with polyglot functions, in accordance with an embodiment of this disclosure;

FIG. 13 illustrates another example process flow that can facilitate FaaS fusion deployment with polyglot functions, in accordance with an embodiment of this disclosure;

FIG. 14 illustrates an example block diagram of a computer operable to execute an embodiment of this disclosure.

### DETAILED DESCRIPTION

### Overview

FaaS can comprise a service allocated by a cloud platform to achieve a “serverless” execution model. In this form of execution, a cloud services platform can be leveraged to control most aspects of execution layers, allowing the developer to focus on business logic.

Using a FaaS platform to execute code can provide benefits. A benefit can be an improved time to market, where developers are focused on business value rather than operational aspects of deployment and maintenance, which can facilitate faster development cycles.

Another benefit can relate to compute resources and cost. A characteristic of containerized functions can be ephemerality, where functions can be short-lived and can scale to zero. Using a FaaS platform can benefit a system in terms of cost and compute resources, where some part of an application remains dormant until needed.

A problem with FaaS can relate to cascading execution of functions. In an example, functions can call each other serially to consume some business logic. These calls can increase an overall execution time, where each function is provisioned separately.

Consider an example where there are three deployed functions: F1( ), F2( ), and F3( ). There can be different initialization times for each function based on their respective code base. In this example, F1( ) can have a 200 millisecond (ms) initialization time, F2( ) can have a 300 ms initialization time, and F3( ) can have a 400 ms initialization time.

If these functions are initialized serially, a corresponding user request will be idle for nearly a second.

These deployment side effects can be difficult to predict during development, and can cause a major increase in cost and resources in production.

Another problem with FaaS can relate to increased resource consumption. Deploying an entire application as separate functions can result in increased resource consumption when part of the application is used occasionally, contrary to a traditional deployment. When functions are not scaled to zero, an advantage of using a serverless execution model can be lost.

Another problem with FaaS can relate to low performance. Serial execution of functions can lead to an increased execution time where each function in the pipeline needs to be provisioned separately. Provisioning can be slower in certain runtimes resulting in low performance and more idle time until the event is processed.

The present techniques can be implemented to mitigate against these problems with FaaS. In some examples according to the present techniques, a system dynamically collects information of deployed functions, and performs a fusion of multiple functions into a single container. This approach can facilitate reusing a management part of a PaaS platform in a single container, which can reduce costs and resources.

The present techniques can be implemented as follows. A system can perform analysis to identify cascading function calls, can fuse the corresponding functions together, and will trigger a deployment in order for changes to take effect.

In some examples, the system can have two possible modes of analyzing and deploying cascading function calls—static and dynamic. Static analysis can be based on recognizing interrelated function calls in source code. Dynamic analysis can be based on recognizing cascading function calls based on metrics collected during runtime.

In some examples, either static analysis or dynamic analysis can be implemented based on the characteristics of a system that executes the functions.

Implementing the present techniques can reduce compute resources used in executing functions by merging functions together into a single container. The present techniques can facilitate applying a dynamic behavior to a deployed application, while avoiding problems in legacy approaches of application deployment from microservice or monolithic perspectives.

The proposed solution demonstrates the ability to reduce compute resources by merging one or more functions together to a single container. This approach allows a more dynamic behavior to deployed application while avoiding problems in legacy approaches of application deployment from microservice or monolithic perspectives.

The present techniques can facilitate dynamic FaaS reallocation to collect runtime execution information to identify optimized function execution groups. The present techniques can also facilitate fuse containerized functions that merge functions after deployment into a single container.

The present techniques can be implemented to facilitate fusing functions based on container runtime, via a polyglot merging system. Functions can be aggregated based on various conditions.

In some examples, merging can be limited to merging functions in containers that have the same runtime environment, like runtime environments that correspond to Java, Python, and/or Golang programming languages. In some examples, merging can be limited to merging functions in containers that have the same runtime version (e.g., version 3.8 of a runtime), where mixing workloads that depend on different versions of the same runtime can lead to multiple compatibility problems.

Functions can be developed in different languages. A polyglot analyzer according to the present techniques can be implemented to aggregate functions in a manner that is agnostic to runtime.

The present techniques can be implemented to analyze FaaS container configurations of functions that will be fused together. Then, based on defined runtimes and their versions that are identified in those container configurations, an image can be created that includes the fused functions, as well as the runtimes they depend on.

Dynamic analysis of functions, as described herein, can be performed. Then, an appropriate FaaS configuration can be scanned to determine its runtime and runtime version. In some examples, alternatively, a code scan of a corresponding container configuration can be performed if language or version details are missing in the FaaS configuration. An image can be created that includes the runtimes for the functions being merged. The functions can be merged, as described herein, where each function within the fusion container is matched to its corresponding runtime and runtime version. A workload that comprises the fused functions can be activated.

Configurations for FaaS and or configurations for a container in which functions can execute can be stored in a source control alongside source code for functions and/or applications.

Matching a function to its corresponding runtime in a container can generally comprise running the function over the runtime. There can be multiple runtimes in a fused container, e.g., Java and Python runtimes. In one container, a Java-based function can be run over a Java runtime (e.g., by invoking a command “java-jar myapp.jar” where myapp.jar corresponds to the function), and a Python-based function can be run over a Python runtime (e.g., by invoking a command “python myapp.py” where myapp.py corresponds to the function),

The present techniques can be implemented to facilitate a dynamic polyglot system that factors in language runtime for performing function fusion. A benefit of the present techniques can be an ability to fuse function in multi-lingual and multi-versioned environments, thus handling function fusion across a wide spectrum of real-world systems.

### Example Architectures

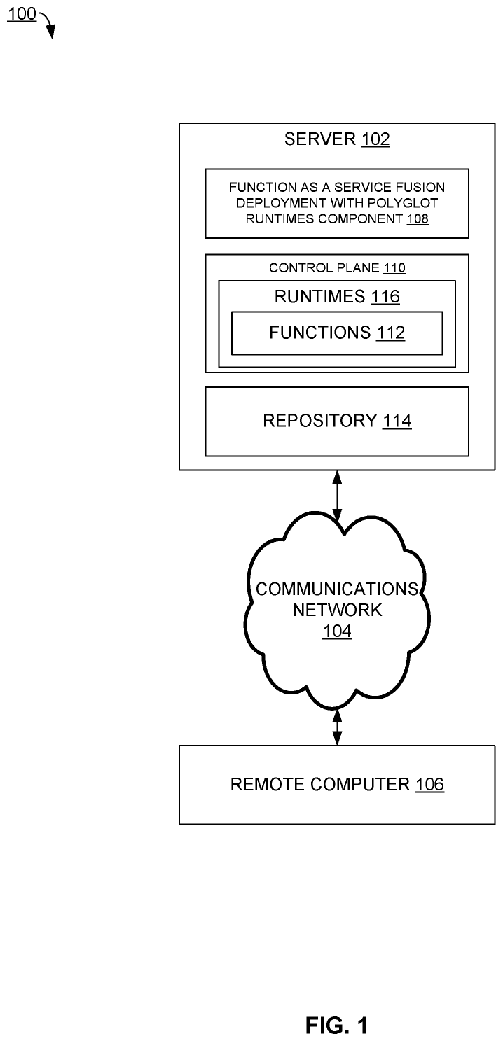

FIG. 1 illustrates an example system architecture 100 that can facilitate FaaS fusion deployment with polyglot functions in accordance with an embodiment of this disclosure.

System architecture 100 comprises server 102, communications network 124, and remote computer 106. In turn, server 102 comprises FaaS fusion deployment with polyglot functions component 108, control plane 110 (which comprises runtimes 116 and functions 112), and repository 114.

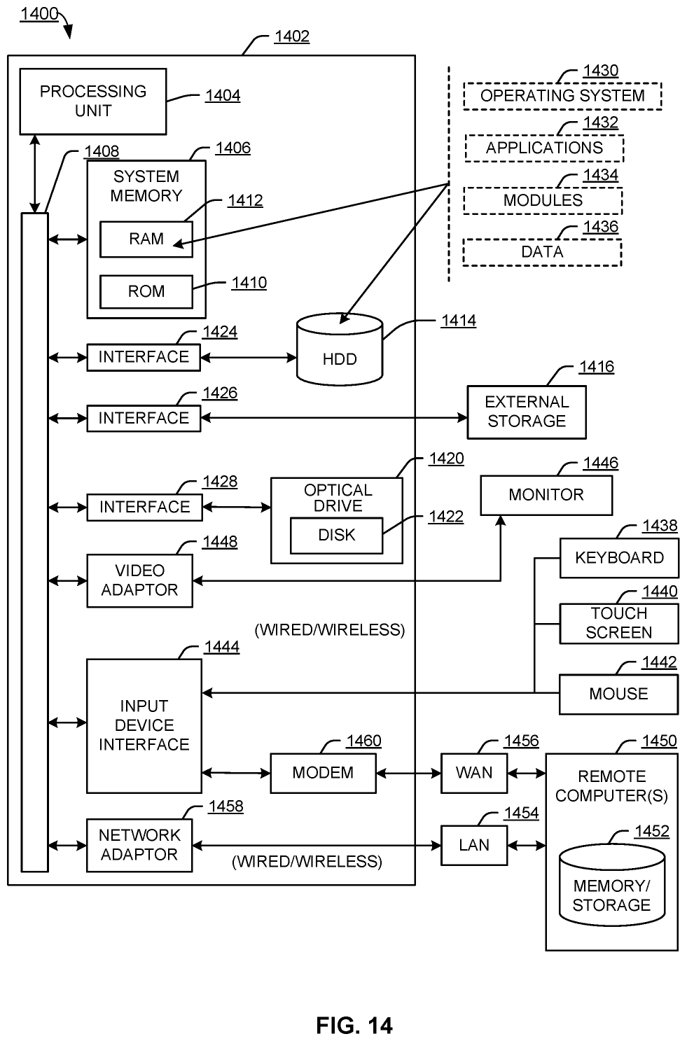

Each of server 102 and/or remote computer 106 can be implemented with part(s) of computing environment 1400 of FIG. 14. Communications network 124 can comprise a computer communications network, such as the Internet.

Control plane 110 can generally manage deployed functions 112. Respective functions of functions 112 can be configured to execute in respective runtimes of runtimes 116, where the respective runtimes can be different (e.g., different language runtimes and/or versions of language runtimes). Respective functions of functions 112 can comprise computer-executable code that can be invoked. Repository 114 can store uncompiled code of functions 112 that can be compiled and deployed to control plane 110.

Remote computer 106 can contact server 102 via communications network 124 to invoke functions of functions 112, such as those that comprise a web application. FaaS fusion deployment with polyglot functions component 108 can identify functions of functions 112 that can be merged, or fused, into one container and effectuate that fusion.

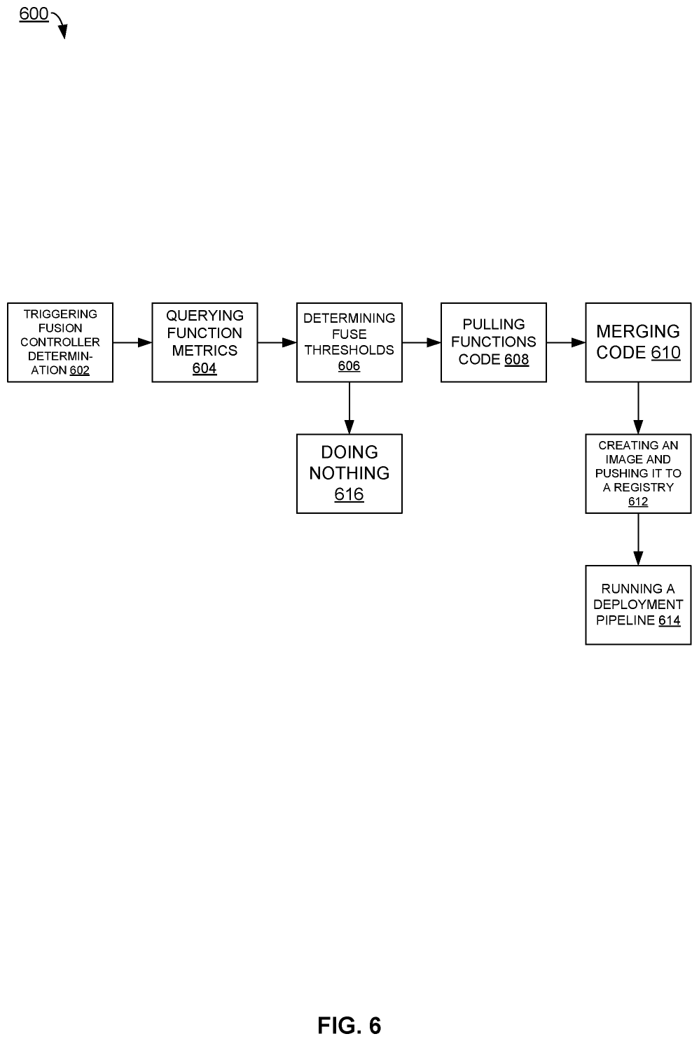

In some examples, FaaS fusion deployment with polyglot functions component 108 can implement part(s) of the process flows of FIGS. 6 and/or 11-13 to implement FaaS fusion deployment with polyglot functions.

It can be appreciated that system architecture 100 is one example system architecture for generating and distributing security policies in a containerized environment, and that there can be other system architectures that facilitate generating and distributing security policies in a containerized environment.

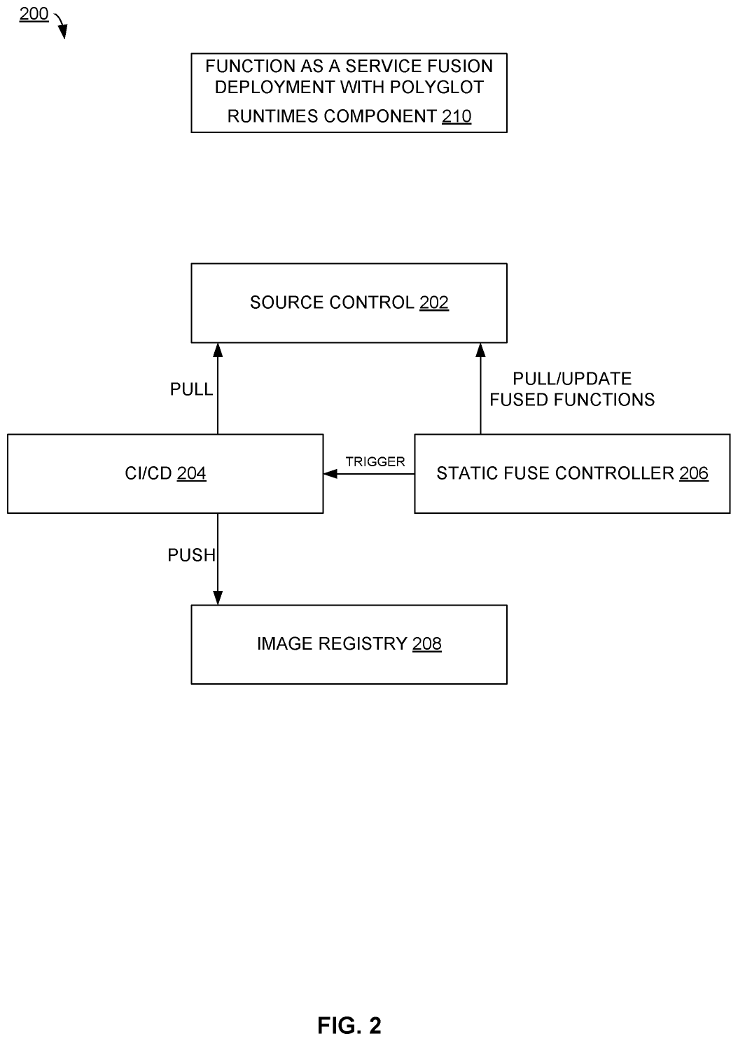

FIG. 2 illustrates an example system architecture 200 for static function analysis that can facilitate FaaS fusion deployment with polyglot functions, in accordance with an embodiment of this disclosure. In some examples, part(s) of system architecture 200 can be used to implement part(s) of system architecture 100 of FIG. 1 to facilitate FaaS fusion deployment with polyglot functions.

System architecture 200 comprises source control 202, continuous integration (CI)/continuous deployment (CD) 204, static fuse controller 206, image registry 208, and FaaS fusion deployment with polyglot functions component 210.

Source control 202 can be similar to repository 114 of FIG. 1, and can store configurations for FaaS and/or configurations for containers. CI/CD 204 can generally comprise a component that integrates changes to code for a containerized function, and then deploys an image of that containerized function to image registry 208. Image registry 208 can comprise a registry of function container images that can be instantiated and executed when the corresponding function is invoked. FaaS fusion deployment with polyglot functions component 210 can be similar to FaaS fusion deployment with polyglot functions component 108 of FIG. 1.

Static analysis and provisioning can be performed as follows. Static analysis can be performed on a function's code base to identify areas where there are cascading calls to different functions.

In some examples, static analysis can generally be performed in three parts: perform code analysis from source control and function call graph; decide a function merge strategy; and merge the functions and push updates.

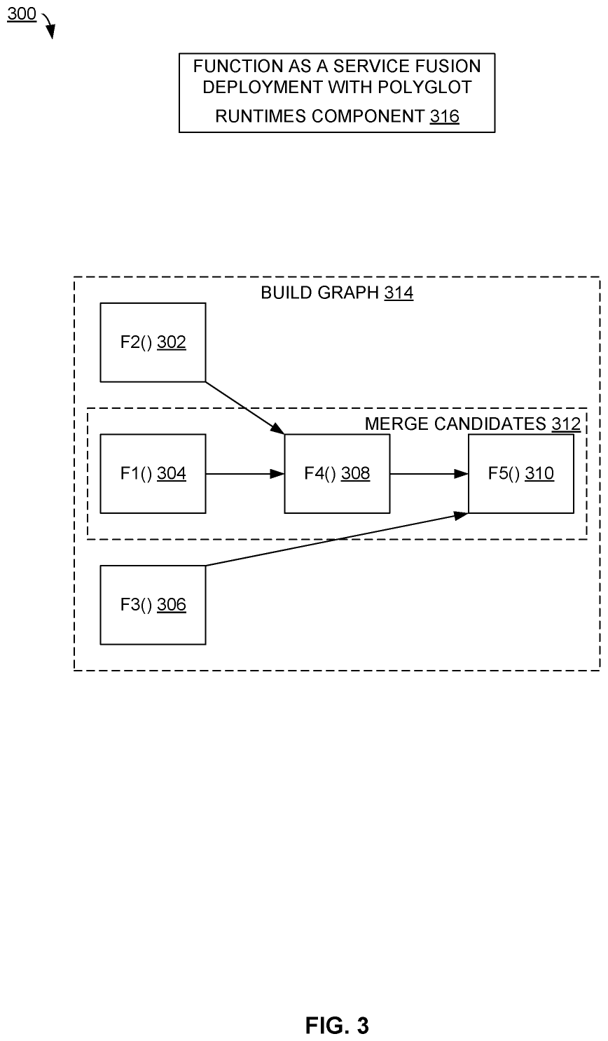

Static fuse controller 206 can generally be responsible for iterating over function code modules and building a function call graph (similar to FIG. 3). A FaaS platform that manages the functions can also be responsible for wrapping the runtime components in dedicated network handlers (e.g., services), which can facilitate static fuse controller 206 in identifying calls inside the code to different functions and building the execution graph.

FIG. 3 illustrates another example system architecture 300 for static function analysis that can facilitate FaaS fusion deployment with polyglot functions, in accordance with an embodiment of this disclosure. In some examples, part(s) of system architecture 300 can be used to implement part(s) of system architecture 100 of FIG. 1 to facilitate FaaS fusion deployment with polyglot functions.

System architecture 300 comprises FaaS fusion deployment with polyglot functions component 316, and build graph 314. In turn, build graph 314 comprises F2( ) 302, F1( ) 304, F3( ) 306, F4( ) 308, F5( ) 310, and merge candidates 312. FaaS fusion deployment with polyglot functions component 316 can be similar to FaaS fusion deployment with polyglot functions component 108 of FIG. 1.

Build graph 314 can comprise a graph of functions and their dependencies that is generated based on a static analysis of those functions' code. Here, there are five functions analyzed, and used to make nodes in build graph 314—F2( ) 302, F1( ) 304, F3( ) 306, F4( ) 308, F5( ) 310. F1( ) 304, F4( ) 308, and F5( ) 310 can be identified as potential merge candidates 312 because they have been identified to be part of a cascading series of function calls. That is, in this example, F1( ) 304 invokes F4( ) 308; and similarly, F4( ) 308 invokes F5( ) 310.

Build graph 314 can be used to identify a maximum depth possible to merge groups of functions.

Build graph 314 can be used to determine to merge F1( ) 304, F4( ) 308, and F5( ) 310, to save a potential idle time in a function cold start. In some examples, F2( ) 302 and F3( ) 306 can also be added, though it could be that this causes initialization time to stack up and exceed a time of serial execution.

Where F2( ) 302 and F3( ) 306 are to be executed in parallel, they can be kept outside of a fused container.

In some examples, a static fuse controller (e.g., static fuse controller 206 of FIG. 2) can identify potential function size and package testing. For example, functions that contain a large code base and packages can be prioritized over functions with a smaller footprint when deciding on a merge strategy of functions in a same depth.

After code is merged back into source control as fused functions, a pipeline can be triggered to build a new image and store it in an image registry. A CI/CD component (e.g., CI/CD 204 of FIG. 2) can override previously deployed functions to prevent building and deploying them.

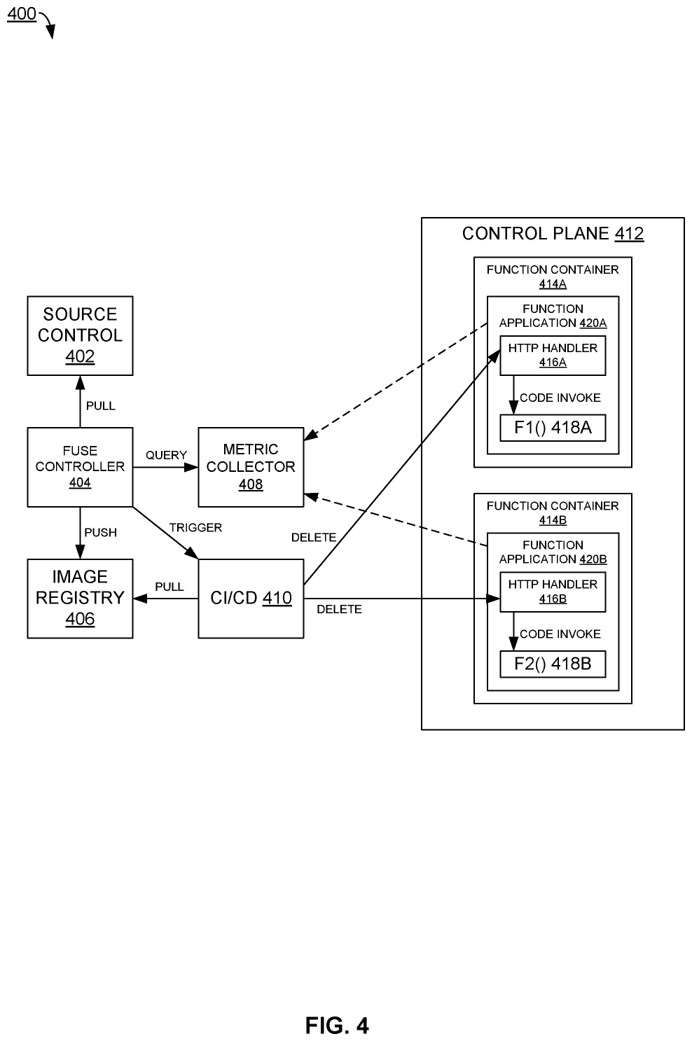

FIG. 4 illustrates an example system architecture 400 for dynamic function analysis that can facilitate FaaS fusion deployment with polyglot functions, in accordance with an embodiment of this disclosure. In some examples, part(s) of system architecture 400 can be used to implement part(s) of system architecture 100 of FIG. 1 to facilitate FaaS fusion deployment with polyglot functions.

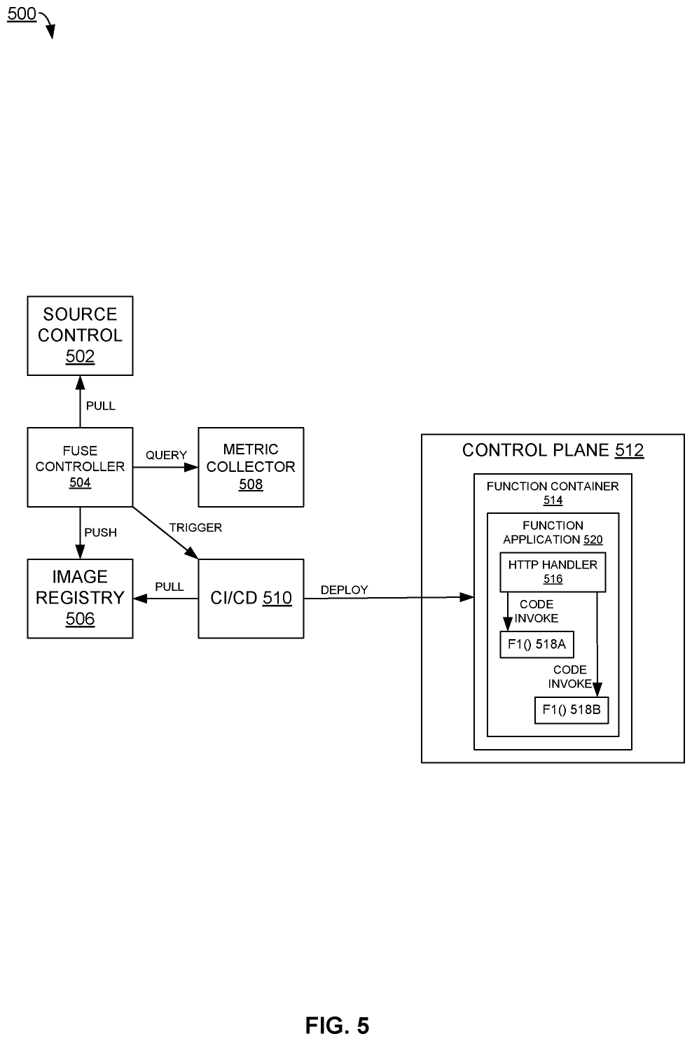

Generally, FIG. 4 can depict an example where multiple functions execute in separate containers. That is, F1( ) 418A executes in function container 414A, and F2( ) 418B executes in function container 414B. Then, generally, FIG. 5 can depict the example of FIG. 4 after the two functions have been fused to execute within one container. In the example of FIG. 4, F1( ) 418A and F2( ) 418B can be analyzed to determine that they will be fused.

System architecture 400 comprises source control 402, fuse controller 404, image registry 406, metric collector 408, CI/CD 410, and control plane 412. In turn, control plane 412 comprises function container 414A, hypertext transfer protocol (HTTP) handler 416A (it can be appreciated that this is an example, and other types of handlers can be implemented), F1( ) 418A, function application 420A, function container 414B, HTTP handler 416B, F2( ), and function application 420B.

Source control 402 can be similar to source control 202 of FIG. 2. Fuse controller 404 can be similar to static fuse controller 206, except that fuse controller 404 is configured to fuse functions based on dynamic analysis while static fuse controller 206 is configured to fuse functions based on static analysis. Image registry 406 can be similar to image registry 406.

Metric collector 408 can be a component that is configured to measure dynamic metrics of functions in control plane 412, as described herein. CI/CD 410 can be similar to CI/CD 204. Control plane 412 can generally manage functions deployed by CI/CD 410.

Each of function container 414A and function container 414B can comprise a container, where a container can generally package executable computer code (e.g., a function) with libraries and dependencies that are invoked by the code. HTTP handler 416A and HTTP handler 416B can each comprise a management layer for a FaaS platform that is configured to process HTTP messages. F1( ) 418A and F2( ) 418B can be different functions. Function application 420A and function application 420B can comprise a part of function container 414A and function container 414B that supports execution of a function.

Dynamic analysis and provisioning can be implemented as follows. In some examples, static code analysis can be implemented where there are limited compute resources on a runtime environment, but it can be that there are limited results for function fusing because the data used to determine which functions to fuse is not based on live events.

In other examples, more compute resources in production can be used to make a fusion decision in an initial evaluation period through dynamic analysis.

In some examples, dynamic analysis can generally be performed in three parts: collecting metric data from a runtime environment (e.g., by metric collector 408); identifying when a set of functions can be fused together using collected data (e.g., by fuse controller 404); and fusing functions and running a CI/CD pipeline (e.g., CI/CD 410) to deploy the fused functions and delete a previous revision (e.g., by fuse controller 404).

Control plane 412 can generally comprise a deployment environment, and can be part of a container orchestrator. Functions (e.g., F1( ) 418A and F2( ) 418B) can be deployed inside containers. In some examples, each function can have a management layer for a FaaS platform, and this management layer can be implemented as a HTTP request handler (e.g., HTTP handler 416A and HTTP handler 416B).

Metric collector 408 can pull runtime execution data for functions or a platform in order to use that information to make a fusion decision.

Fuse controller 404 can pull metric data (e.g., from metric collector 408) and analyze the data to make a decision on which functions or function groups to merge. In some examples, fuse controller 404 can take into account the following information in determining a merge strategy:
1. Whether the functions are called above a threshold percentage of the time together, where the threshold is a predefined system parameter;
2. Whether the functions are called within a threshold amount of time of each other, where the threshold is a predefined system parameter;
3. Sampling that is collected through a time period, where a decision is made after the time period, and the time period is a predefined system parameter;
4. Sampling that is collected through a number of requests, where the number of requests is a predefined system parameter.

In some examples, other metrics can be utilized.

Where a decision is made to merge or repackage functions, fuse controller 404 can pull the code of the functions and package it together in one image. A new image can then be built from merged code and a CI/CD pipeline (e.g., CI/CD 410) can be triggered to deploy the new image and delete corresponding existing functions.

FIG. 5 illustrates another example system architecture 500 for dynamic function analysis that can facilitate FaaS fusion deployment with polyglot functions, in accordance with an embodiment of this disclosure. In some examples, part(s) of system architecture 500 can be used to implement part(s) of system architecture 100 of FIG. 1 to facilitate FaaS fusion deployment with polyglot functions.

System architecture 500 comprises source control 502, fuse controller 504, image registry 506, metric collector 508, CI/CD 510, and control plane 512. In turn, control plane 512 comprises function container 514, HTTP handler 516, F1( ) 518A, F2( ) 518B, and function application 520.

Source control 502 can be similar to source control 402 of FIG. 4; fuse controller 504 can be similar to fuse controller 404; image registry 506 can be similar to image registry 406; metric collector 508 can be similar to metric collector 408; CI/CD 510 can be similar to CI/CD 410; control plane 512 can be similar to control plane 412; function container 514 ca be similar to function container 414A; HTTP handler 516 can be similar to HTTP handler 416A; F1( ) 518A can be similar to F1( ) 418A; F2( ) 518B can be similar to F2( ) 418B; and function application 520 can be similar to function application 420A.

System architecture 500 can represent system architecture 400 after F1( ) 418A and F2( ) 418B have been fused from operating in separate containers (function container 414A and function container 414B, respectively) to operating in one container (function container 514). In system architecture 500, HTTP handler 516 can receive calls for both F1( ) 518A and F2( ) 518B and direct calls to the appropriate function.

### Example Process Flow

FIG. 6 illustrates an example process flow 600 for dynamic function analysis that can facilitate FaaS fusion deployment with polyglot functions, in accordance with an embodiment of this disclosure. In some examples, one or more embodiments of process flow 600 can be implemented by FaaS fusion deployment with polyglot functions component 108 of FIG. 1, or computing environment 1400 of FIG. 14.

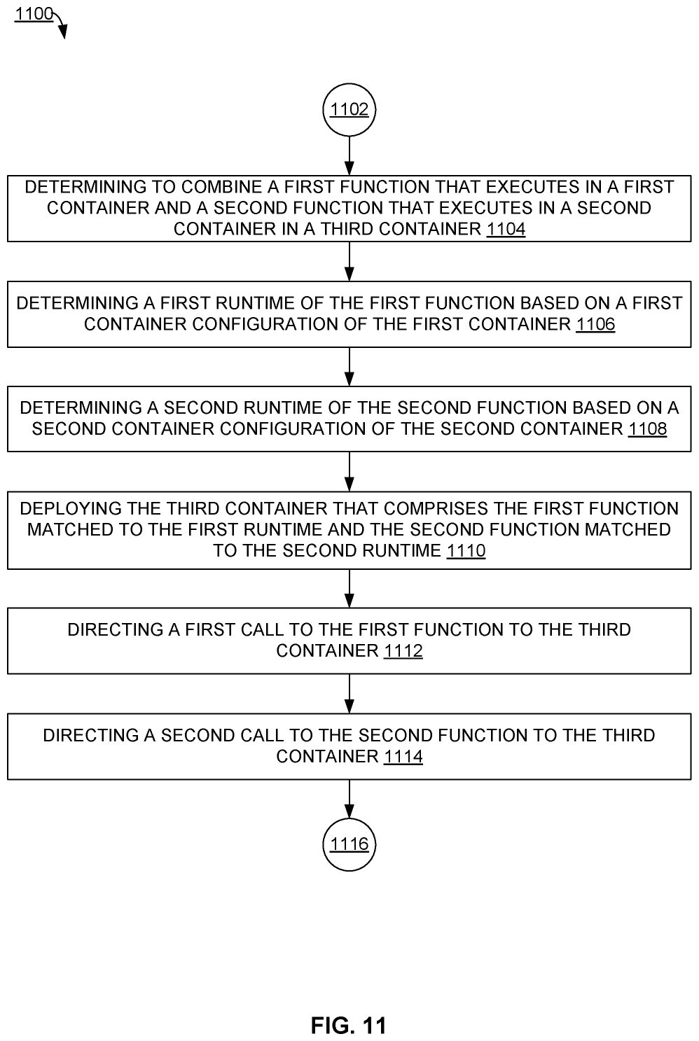

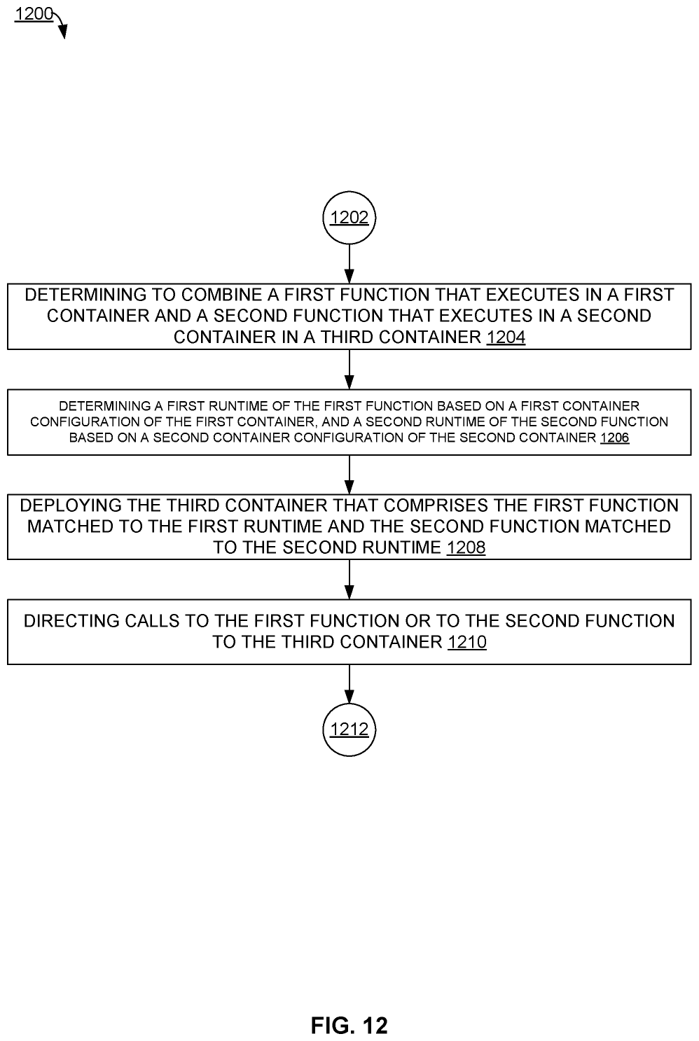

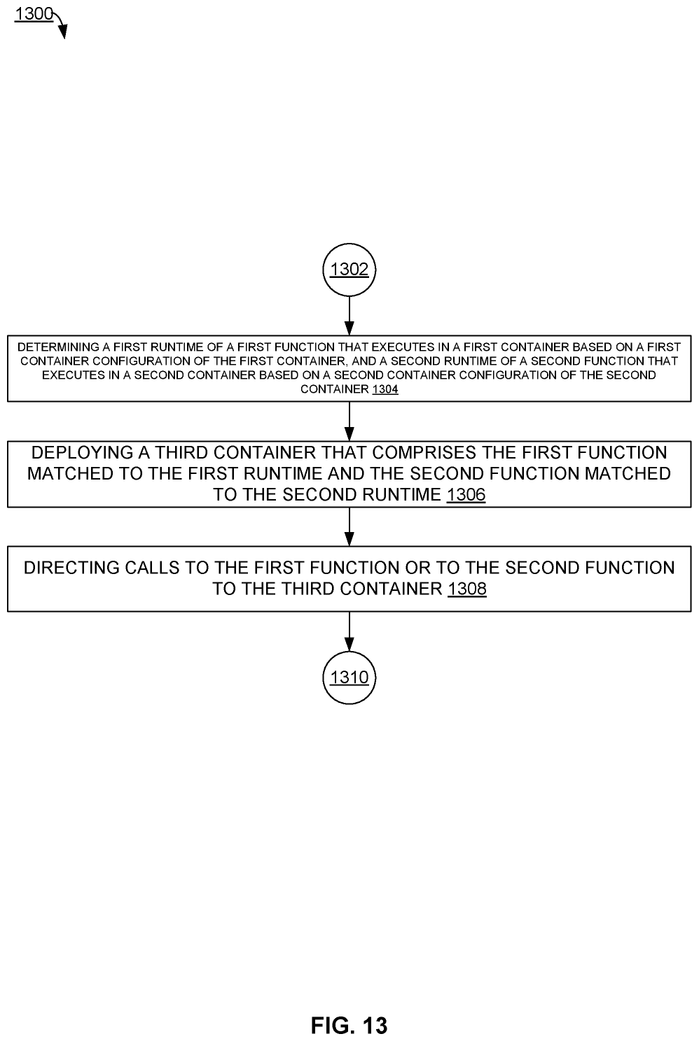

It can be appreciated that the operating procedures of process flow 600 are example operating procedures, and that there can be embodiments that implement more or fewer operating procedures than are depicted, or that implement the depicted operating procedures in a different order than as depicted. In some examples, process flow 600 can be implemented in conjunction with one or more embodiments of one or more of process flow 1100 of FIG. 11, process flow 1200 of FIG. 12, and/or process flow 1300 of FIG. 13.

In some examples, process flow 600 can be implemented on system architecture 400 of FIG. 4 to perform the function fusion depicted in system architecture 500 of FIG. 5.

Process flow 600 begins with operation 602. Operation 602 depicts triggering fusion controller determination. In some examples, this can be dynamic analysis that is performed periodically on executing functions, or when functions are initially deployed.

After operation 602, process flow 600 moves to operation 604.

Operation 604 depicts querying function metrics. This can be similar to tasks performed by metric collector 408 of FIG. 4.

After operation 604, process flow 600 moves to operation 606.

Operation 606 depicts determining fuse thresholds. These can be thresholds as described herein. Where in operation 606 it is determined that the fuse thresholds are met, process flow 600 moves to operation 608. Instead, where in operation 606 it is determined that the fuse thresholds are not met, process flow 600 moves to operation 616.

Operation 608 is reached from operation 606 where it is determined that the fuse thresholds are met. Operation 608 depicts pulling functions code. That is, code for the functions that will be fused can be pulled from a repository, such as repository 114 of FIG. 1.

After operation 608, process flow 600 moves to operation 610.

Operation 610 depicts merging code. This can involve merging the code pulled in operation 608 so that it can execute in one controller.

After operation 610, process flow 600 moves to operation 612.

Operation 612 depicts creating an image and pushing it to a registry. This can be an image of the merged code from operation 610, and the registry can be similar to image registry 406 of FIG. 4.

After operation 612, process flow 600 moves to operation 614.

Operation 614 depicts running a deployment pipeline. This can comprise CI/CD 410 of FIG. 4 running a deployment pipeline on the registered image.

After operation 614, process flow 600 ends.

Operation 616 is reached from operation 606 where it is determined that the fuse thresholds are not met. Operation 616 depicts doing nothing. That is, it can be determined at this time not to merge functions, so this instance of process flow 600 can end.

After operation 616, process flow 600 ends.

### Example Architectures

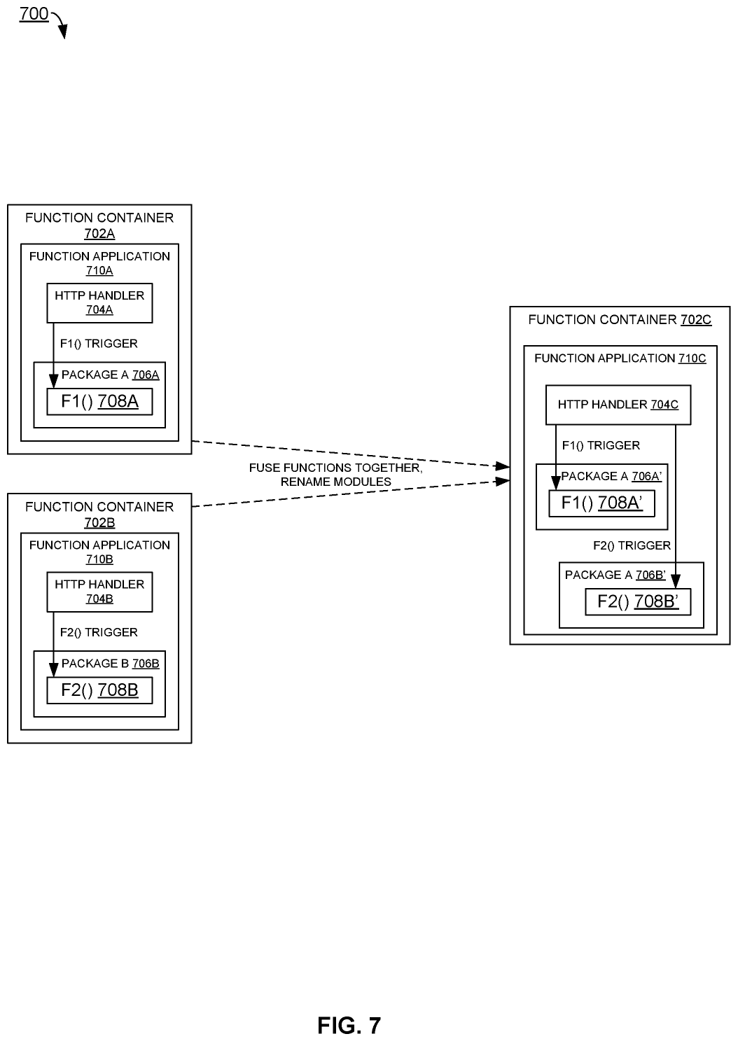

FIG. 7 illustrates an example system architecture 700 for merging functions that can facilitate FaaS fusion deployment with polyglot functions, in accordance with an embodiment of this disclosure. In some examples, part(s) of system architecture 700 can be used to implement part(s) of system architecture 100 of FIG. 1 to facilitate FaaS fusion deployment with polyglot functions.

System architecture 700 comprises function container 702A, HTTP handler 704A, package A 706A, F1( ) 708A, function application 710A, function container 702B, HTTP handler 704B, package B 706B, F2( ) 708B, function application 710B, function container 702C, HTTP handler 704C, package F1( ) 706A′, package F2( ) 706B′, F1( ) 708A′, F2( ) 708B′, and function application 710C.

Function container 702A, function container 702B, and function container 702C can each be similar to an instance of function container 414A of FIG. 4. HTTP handler 704A, HTTP handler 704B, and HTTP handler 704C can each be similar to an instance of HTTP handler 416A. Package A 706A, package F1( ) 706A′, package B 706B, and package F2( ) 706B′ can each be names for packages that contain functions that can be executed. F1( ) 708A, F2( ) 708B, F1( ) 708A′, and F2( ) 708B′ can each be functions. Function application 710A, function application 710B, and function application 710B can each be similar to an instance of function application 420A.

A function merge strategy can be implemented as follows. Function dependency packages can be merged, and similar packages can be consolidated. In some cases, packages can automatically be upgraded to a latest version in a case of collision, and in other cases, packages can be manually consolidated. Whether this is done automatically or manually can be configured, and can be done on a per-application basis, such as based on function testability and coverage confidence.

Code for functions can be copied to the same repository. Each function can be wrapped in a different module based on a runtime language (e.g., a package name, or a directory). A HTTP handler (e.g., HTTP handler 704C) can be routed to trigger an appropriate function module according to a compatible function trigger.

A HTTP handler that triggers a single function can now act as a router that maps a function name to a HTTP route or an event name, thus allowing a selective trigger of a relevant function.

Function container 702C generally comprises a merge of the functions of function container 702A and function container 702B. That is, F1( ) 708A and F1( ) 708A′ can each be the same function executing in different function containers; and so can F2( ) 708B and F2( ) 708B′. After the merge, two functions—F1( ) 708A′ and F2( ) 708B′ can execute in one container.

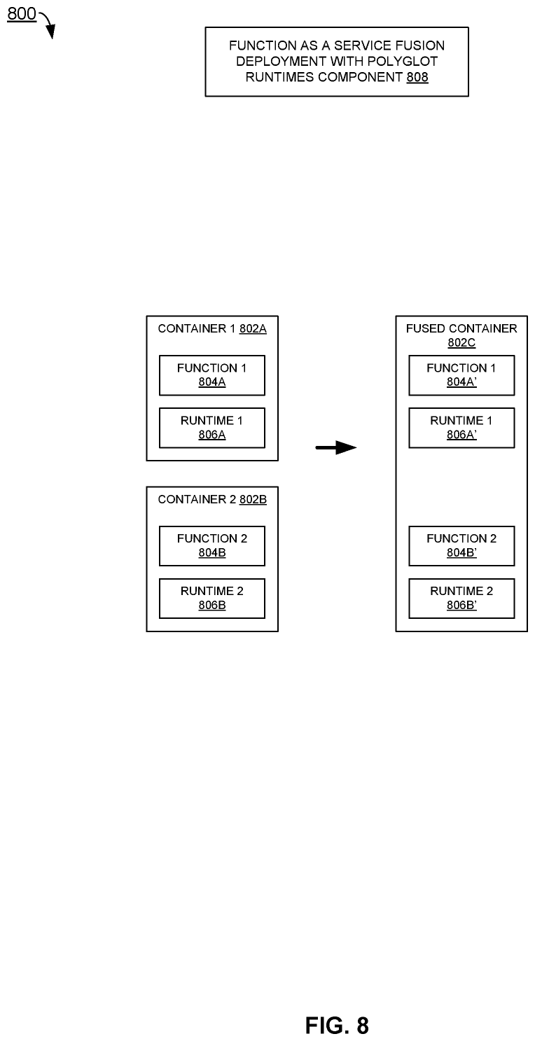

FIG. 8 illustrates an example system architecture 800 for merging functions polyglot functions, and that can facilitate FaaS fusion deployment with polyglot functions, in accordance with an embodiment of this disclosure. In some examples, part(s) of system architecture 800 can be used to implement part(s) of system architecture 100 of FIG. 1 to facilitate FaaS fusion deployment with polyglot functions.

System architecture 800 comprises container 1 802A, container 2 802B, fused container 802C, and FaaS fusion deployment with polyglot functions component 808 (which can be similar to FaaS fusion deployment with polyglot functions component 108 of FIG. 1). In turn, container 1 802A comprises function 1 804A and runtime 1 806A; container 2 802B comprises function 2 804B and runtime 2 806B; and fused container 802C comprises function 1 804A1, function 2 804B′, runtime 1 804A′, and runtime 2 804B′.

Fused container 802C can generally comprise a result of fusing the functions of container 1 802A and container 2 802B. In system architecture 800, runtime 1 806A and runtime 2 806B are different, for example in terms of programming language and/or version.

In performing fusion, fused container 802C can comprise versions of both of these runtimes (indicated as runtime 1 806A and runtime 2 806B). Then, the corresponding fused functions (indicated as function 1 804A′ and function 1 804B′) can be matched to their respective runtimes. In this manner, functions using different runtimes (sometimes referred to as polyglot runtimes) can be fused together in the same container.

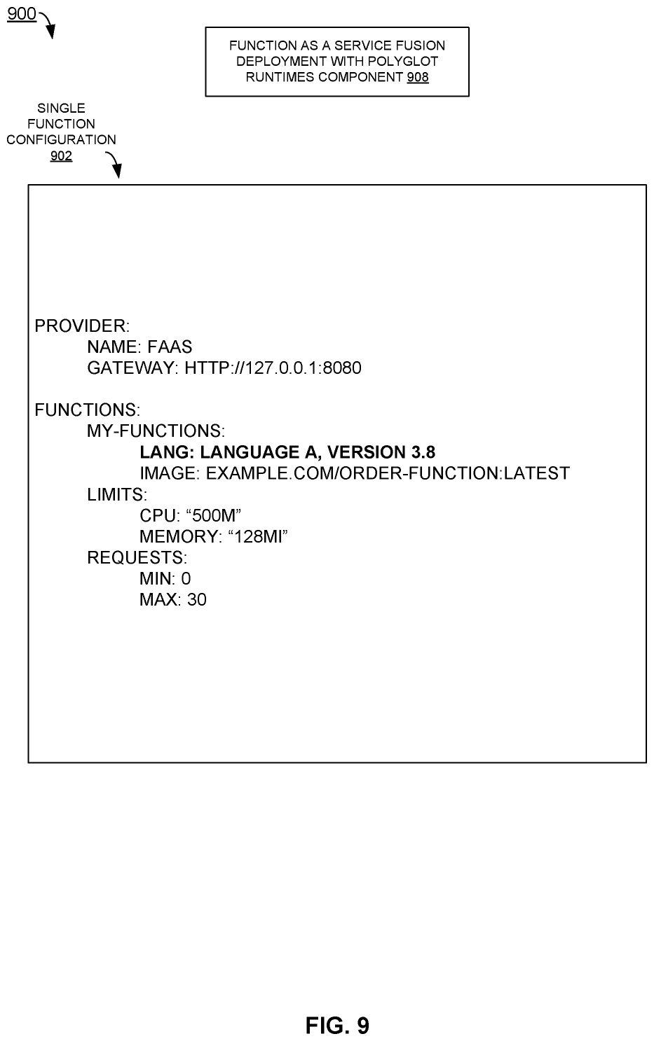

FIG. 9 illustrates an example system architecture 900 for using a configuration file in merging functions polyglot functions, and that can facilitate FaaS fusion deployment with polyglot functions, in accordance with an embodiment of this disclosure. In some examples, part(s) of system architecture 900 can be used to implement part(s) of system architecture 100 of FIG. 1 to facilitate FaaS fusion deployment with polyglot functions.

System architecture 900 comprises single function configuration 902, and FaaS fusion deployment with polyglot functions component 808 (which can be similar to FaaS fusion deployment with polyglot functions component 108 of FIG. 1).

Single function configuration 902 comprises a configuration file for one function. It can be that, in the course of facilitating FaaS fusion deployment with polyglot functions, FaaS fusion deployment with polyglot functions component 808 can read single function configuration 902 and determine runtime information about it, such as a language (e.g., programming language A) and a version of the language (e.g., 3.8).

A FaaS configuration (which can be similar to single function configuration 902) can contain information used to provision a function—e.g., a name of an image containing the function, which runtime the function should be executed on (e.g., Java or Python runtimes), etc.

Where not all runtime information is determined from single function configuration 902, a corresponding container configuration can be accessed to determine this information. A container configuration can generally comprise a build time configuration that indicates how to build an image containing a function.

A container image can also comprise information about the function's runtime, because, as part of building an image from source code, tooling for the language in which the source code is written is stored in the image. This can be seen in the following example container configuration that references version 3.8 of Python programming language:
FROM python:3.8
WORKDIR/app
COPY requirements.txt
RUN pip install--no-cache-dir-r requirements.txt
COPY..
CMD [“python”, “app.py”]

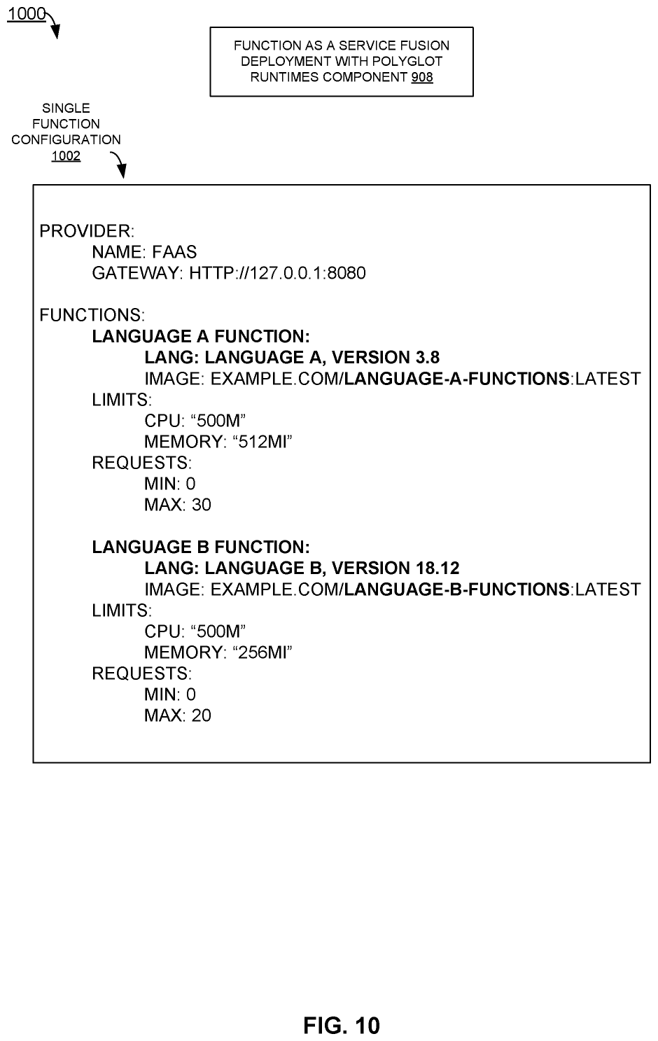

FIG. 10 illustrates another example system architecture 1000 for using a configuration file in merging functions polyglot functions, and that can facilitate FaaS fusion deployment with polyglot functions, in accordance with an embodiment of this disclosure. In some examples, part(s) of system architecture 1000 can be used to implement part(s) of system architecture 100 of FIG. 1 to facilitate FaaS fusion deployment with polyglot functions.

System architecture 1000 comprises multiple function configuration 1002, and FaaS fusion deployment with polyglot functions component 1008 (which can be similar to FaaS fusion deployment with polyglot functions component 108 of FIG. 1).

Multiple function configuration 1002 comprises a configuration file for multiple functions that are being fused together in one container. Where multiple runtimes are used in one fusion container, these can be identified in multiple function configuration 1002 (e.g., programming language A version 3.8 and programming language B version 18.12), so that multiple runtimes can be deployed in the container. Using the example of FIG. 8, these multiple runtimes can be runtime 1 806A′ and runtime 2 806B′, which are deployed together in fused container 802C.

### Example Process Flows

FIG. 11 illustrates an example process flow 1100 that can facilitate FaaS fusion deployment with polyglot functions, in accordance with an embodiment of this disclosure. In some examples, one or more embodiments of process flow 1100 can be implemented by FaaS fusion deployment with polyglot functions component 108 of FIG. 1, or computing environment 1400 of FIG. 14.

It can be appreciated that the operating procedures of process flow 1100 are example operating procedures, and that there can be embodiments that implement more or fewer operating procedures than are depicted, or that implement the depicted operating procedures in a different order than as depicted. In some examples, process flow 1100 can be implemented in conjunction with one or more embodiments of one or more of process flow 600 of FIG. 6, process flow 1200 of FIG. 12, and/or process flow 1300 of FIG. 13.

Process flow 1100 begins with 1102, and moves to operation 1104.

Operation 1104 depicts determining to combine a first function that executes in a first container and a second function that executes in a second container in a third container. This can comprise determining to fuse functions, such as depicted with respect to FIG. 8, where the functions of container 1 802A and container 2 802B are fused in fused container 802C.

After operation 1104, process flow 1100 moves to operation 1106.

Operation 1106 depicts determining a first runtime of the first function based on a first container configuration of the first container. Using the example of FIG. 8, this can comprise determining characteristics of runtime 1 806A for function 1 842A, and can be performed such as by analyzing information for function 1 804A that is similar to single function configuration 902 of FIG. 9.

After operation 1106, process flow 1100 moves to operation 1108.

Operation 1108 depicts determining a second runtime of the second function based on a second container configuration of the second container. In some examples, operation 1108 can be implemented in a similar manner as operation 1106, and for a different function (e.g., for function 2 804B of FIG. 8 where operation 1106 is performed for function 1 804A).

In some examples, a first type of the first runtime differs from a second type of the second runtime. That is, different functions can have different runtimes. In some examples, the first runtime comprises a computer language in which the first function is written (e.g., one runtime can be a Python runtime, and another runtime can be a Java runtime). In some examples, the first runtime comprises a version of the computer language in which the first function is written (e.g., one runtime can by a Python version 3.7 runtime and another runtime can be a Python version 3.8 runtime).

In some examples, determining the first runtime of the first function based on the first container configuration of the first container comprises scanning a fusion configuration that corresponds to a fusion of the first function and the second function, where the first container configuration comprises the fusion configuration.

In some examples, determining the second runtime of the second function based on the second container configuration of the first container comprises scanning the fusion configuration that corresponds to the fusion of the first function and the second function, where the second container configuration comprises the fusion configuration. That is, a FaaS configuration that corresponds to a function can be scanned to determine its runtime and/or its version.

In some examples, determining the first runtime of the first function based on the first container configuration of the first container comprises performing a code scan of a container configuration file of the first container configuration. That is, for example, when language and/or version details are not determined from a FaaS framework, a code scan of a container configuration can be performed to determine at least some of the runtime information.

After operation 1108, process flow 1100 moves to operation 1110.

Operation 1110 depicts deploying the third container that comprises the first function made to the first runtime and the second function matched to the second runtime. This can comprise deploying a container that is similar to fused container 802C of FIG. 8.

After operation 1110, process flow 1100 moves to operation 1112.

Operation 1112 depicts directing a first call to the first function to the third container. That is, after fusion, a call to the first function can be directed to that function in its fused container. Using the example of FIG. 8, this can be directing calls to function 1 to function 1 804A′ in fused container 802C.

After operation 1112, process flow 1100 moves to operation 1114.

Operation 1114 depicts directing a second call to the second function to the third container. In some examples, operation 1108 can be implemented in a similar manner as operation 1112, and for a different function (e.g., calls to function 2 are directed to function 2 804B′ of FIG. 8 where operation 1112 is performed for function 1 and function 1 804A′).

After operation 1114, process flow 1100 moves to 1116, where process flow 1100 ends.

FIG. 12 illustrates another example process flow 1200 that can facilitate FaaS fusion deployment with polyglot functions, in accordance with an embodiment of this disclosure. In some examples, one or more embodiments of process flow 1200 can be implemented by FaaS fusion deployment with polyglot functions component 108 of FIG. 1, or computing environment 1400 of FIG. 14.

It can be appreciated that the operating procedures of process flow 1200 are example operating procedures, and that there can be embodiments that implement more or fewer operating procedures than are depicted, or that implement the depicted operating procedures in a different order than as depicted. In some examples, process flow 1200 can be implemented in conjunction with one or more embodiments of one or more of process flow 600 of FIG. 6, process flow 1100 of FIG. 11, and/or process flow 1300 of FIG. 13.

Process flow 1200 begins with 1202, and moves to operation 1204.

Operation 1204 depicts determining to combine a first function that executes in a first container and a second function that executes in a second container in a third container. In some examples, operation 1204 can be implemented in a similar manner as operation 1104 of FIG. 11.

In some examples, determining to combine the first function that executes in the first container and the second function that executes in the second container is based on determining that the first function invokes the second function. That is, it can be that cascading functions (where one function calls another) are fused in a container, such as to improve a performance of executing the functions.

After operation 1204, process flow 1200 moves to operation 1206.

Operation 1206 depicts determining a first runtime of the first function based on a first container configuration of the first container, and a second runtime of the second function based on a second container configuration of the second container. In some examples, operation 1206 can be implemented in a similar manner as operations 1106-1108 of FIG. 11.

In some examples, operation 1206 comprises, in response to determining that language information of the first runtime is omitted from a fusion configuration that corresponds to a fusion of the first function and the second function, performing a code scan of a container configuration file of the first container configuration. In some examples, operation 1206 comprises, in response to determining that version information of the first runtime is omitted from a fusion configuration that corresponds to a fusion of the first function and the second function, performing a code scan of a container configuration file of the first container configuration. That is, a FaaS configuration that corresponds to a function can be scanned to determine its runtime and/or version. In some examples, where language and/or version details are not determined from a FaaS configuration (or framework), then a code scan of a corresponding container configuration can be performed to determine this information.

After operation 1206, process flow 1200 moves to operation 1208.

Operation 1208 depicts deploying the third container that comprises the first function matched to the first runtime and the second function matched to the second runtime. In some examples, operation 1208 can be implemented in a similar manner as operation 1110 of FIG. 11.

In some examples, deploying the third container comprises terminating the first container, and terminating the second container. The first and second containers can be containers in which the un-fused functions are executed. As part of fusing the functions into a third container, operation of the first and second containers can be terminated.

In some examples, deploying the third container comprises accessing first source code of the first function and second source code of the second function from a repository, packaging the first source code and the second source code into an image of the third container, and deploying the image of the third container. That is, the source code for the two functions can be acquired (such as by accessing a repository that stores the source code). The source code for both functions can be packaged into one container image. An instance of this created image can then be deployed so that the functions can be invoked.

In some examples, the packaging and the deploying are performed by a continuous integration and continuous deployment component. This continuous integration and continuous deployment component can be similar to CI/CD 204 of FIG. 2.

After operation 1208, process flow 1200 moves to operation 1210.

Operation 1210 depicts directing calls to the first function or to the second function to the third container. In some examples, operation 1210 can be implemented in a similar manner as operations 1112-1114 of FIG. 11.

After operation 1210, process flow 1200 moves to 1212, where process flow 1200 ends.

FIG. 13 illustrates another example process flow 1300 that can facilitate FaaS fusion deployment with polyglot functions, in accordance with an embodiment of this disclosure. In some examples, one or more embodiments of process flow 1300 can be implemented by FaaS fusion deployment with polyglot functions component 108 of FIG. 1, or computing environment 1400 of FIG. 14.

It can be appreciated that the operating procedures of process flow 1300 are example operating procedures, and that there can be embodiments that implement more or fewer operating procedures than are depicted, or that implement the depicted operating procedures in a different order than as depicted. In some examples, process flow 1300 can be implemented in conjunction with one or more embodiments of one or more of process flow 600 of FIG. 6, process flow 1100 of FIG. 11, and/or process flow 1200 of FIG. 12.

Process flow 1300 begins with 1302, and moves to operation 1304.

Operation 1304 depicts determining a first runtime of a first function that executes in a first container based on a first container configuration of the first container, and a second runtime of a second function that executes in a second container based on a second container configuration of the second container. In some examples, operation 1304 can be implemented in a similar manner as operations 1104-1108 of FIG. 11.

In some examples, determining the first runtime of the first function that executes in the first container based on the first container configuration of the first container comprises scanning a fusion configuration that corresponds to a fusion of the first function and the second function, where the first container configuration comprises the fusion configuration.

In some examples, determining the second runtime of the second function that executes in the second container based on the second container configuration of the second container comprises scanning the fusion configuration that corresponds to the fusion of the first function and the second function, where the second container configuration comprises the fusion configuration.

In some examples, the first runtime and the second runtime have different types. In some examples, the first runtime comprises a type of a computer language. In some examples, the first runtime comprises a version of a computer language.

After operation 1304, process flow 1300 moves to operation 1306.

Operation 1306 depicts deploying a third container that comprises the first function matched to the first runtime and the second function matched to the second runtime. In some examples, operation 1306 can be implemented in a similar manner as operation 1110 of FIG. 10.

After operation 1306, process flow 1300 moves to operation 1308.

Operation 1308 depicts directing calls to the first function or to the second function to the third container. In some examples, operation 1308 can be implemented in a similar manner as operation 1114 of FIG. 10.

After operation 1308, process flow 1300 moves to 1310, where process flow 1300 ends.

Operation 1304 depicts identifying a first container that is configured to be executed, and a second container that is configured to be executed, wherein the first container comprises a first function, wherein the second container comprises a second function, and wherein the first function invokes the second function. In some examples, operation 1304 can be implemented in a similar manner as operations 1104-908 of FIG. 11.

After operation 1304, process flow 1300 moves to operation 1306.

Operation 1306 depicts determining a first expenditure associated with executing a third container that comprises the first function and the second function. In some examples, operation 1306 can be implemented in a similar manner as operation 1110 of FIG. 11.

In some examples, the first expenditure is determined based on an amount of memory and storage associated with executing each of the first function and the second function, and a number of instances of the at least one instance of the third container. That is, a cost of fusing functions can generally relate to a cost of computing resources of executing superfluous function instances.

After operation 1306, process flow 1300 moves to operation 1308.

Operation 1308 depicts determining a second expenditure associated with a group of service level agreement violations that correspond to executing the first container and the second container. In some examples, operation 1308 can be implemented in a similar manner as operation 1112 of FIG. 11.

In some examples, the second expenditure is determined based on an amount of time associated with a cold start of an instance of the first container or the second container, and a rate of occurrence of the cold start. That is, a cost of not fusing functions can generally relate to a cost of SLA violations due to a slower execution time compared to fusing functions.

After operation 1308, process flow 1300 moves to operation 1310.

Operation 1310 depicts, in response to determining that the first expenditure is less than the second expenditure, executing at least one instance of the third container. In some examples, operation 1310 can be implemented in a similar manner as operation 1114 of FIG. 11.

In some examples, operation 1310 comprises, in response to determining that the second expenditure is less than the first expenditure, refraining from executing the at least one instance of the third container. That is, where there is a lower cost to not applying fusion, it can be that the functions are continued to be executed in their separate containers rather than fused together.

After operation 1310, process flow 1300 moves to 1312, where process flow 1300 ends.

### Example Operating Environment

In order to provide additional context for various embodiments described herein, FIG. 14 and the following discussion are intended to provide a brief, general description of a suitable computing environment 1400 in which the various embodiments of the embodiment described herein can be implemented.

For example, parts of computing environment 1400 can be used to implement one or more embodiments of server 102 and/or remote computer 106 of FIG. 1.

In some examples, computing environment 1400 can implement one or more embodiments of the process flows of FIGS. 6 and/or 11-13 to facilitate FaaS fusion deployment with polyglot functions.

While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 14, the example environment 1400 for implementing various embodiments described herein includes a computer 1402, the computer 1402 including a processing unit 1404, a system memory 1406 and a system bus 1408. The system bus 1408 couples system components including, but not limited to, the system memory 1406 to the processing unit 1404. The processing unit 1404 can be any of various commercially available processors. Dual microprocessors and other multi-processor architectures can also be employed as the processing unit 1404.

The system bus 1408 can be any of several types of bus structure that can further interconnect to a memory bus (with or without a memory controller), a peripheral bus, and a local bus using any of a variety of commercially available bus architectures. The system memory 1406 includes ROM 1410 and RAM 1412. A basic input/output system (BIOS) can be stored in a nonvolatile storage such as ROM, erasable programmable read only memory (EPROM), EEPROM, which BIOS contains the basic routines that help to transfer information between elements within the computer 1402, such as during startup. The RAM 1412 can also include a high-speed RAM such as static RAM for caching data.

The computer 1402 further includes an internal hard disk drive (HDD) 1414 (e.g., EIDE, SATA), one or more external storage devices 1416 (e.g., a magnetic floppy disk drive (FDD) 1416, a memory stick or flash drive reader, a memory card reader, etc.) and an optical disk drive 1420 (e.g., which can read or write from a CD-ROM disc, a DVD, a BD, etc.). While the internal HDD 1414 is illustrated as located within the computer 1402, the internal HDD 1414 can also be configured for external use in a suitable chassis (not shown). Additionally, while not shown in environment 1400, a solid state drive (SSD) could be used in addition to, or in place of, an HDD 1414. The HDD 1414, external storage device(s) 1416 and optical disk drive 1420 can be connected to the system bus 1408 by an HDD interface 1424, an external storage interface 1426 and an optical drive interface 1428, respectively. The interface 1424 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1402, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1412, including an operating system 1430, one or more application programs 1432, other program modules 1434 and program data 1436. All or portions of the operating system, applications, modules, and/or data can also be cached in the RAM 1412. The systems and methods described herein can be implemented utilizing various commercially available operating systems or combinations of operating systems.

Computer 1402 can optionally comprise emulation technologies. For example, a hypervisor (not shown) or other intermediary can emulate a hardware environment for operating system 1430, and the emulated hardware can optionally be different from the hardware illustrated in FIG. 14. In such an embodiment, operating system 1430 can comprise one virtual machine (VM) of multiple VMs hosted at computer 1402. Furthermore, operating system 1430 can provide runtime environments, such as the Java runtime environment or the .NET framework, for applications 1432. Runtime environments are consistent execution environments that allow applications 1432 to run on any operating system that includes the runtime environment. Similarly, operating system 1430 can support containers, and applications 1432 can be in the form of containers, which are lightweight, standalone, executable packages of software that include, e.g., code, runtime, system tools, system libraries and settings for an application.

Further, computer 1402 can be enabled with a security module, such as a trusted processing module (TPM). For instance, with a TPM, boot components hash next in time boot components, and wait for a match of results to secured values, before loading a next boot component. This process can take place at any layer in the code execution stack of computer 1402, e.g., applied at the application execution level or at the operating system (OS) kernel level, thereby enabling security at any level of code execution.

A user can enter commands and information into the computer 1402 through one or more wired/wireless input devices, e.g., a keyboard 1438, a touch screen 1440, and a pointing device, such as a mouse 1442. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1404 through an input device interface 1444 that can be coupled to the system bus 1408, but can be connected by other interfaces, such as a parallel port, an IEEE 1394 serial port, a game port, a USB port, an IR interface, a BLUETOOTH® interface, etc.

A monitor 1446 or other type of display device can be also connected to the system bus 1408 via an interface, such as a video adapter 1448. In addition to the monitor 1446, a computer typically includes other peripheral output devices (not shown), such as speakers, printers, etc.

The computer 1402 can operate in a networked environment using logical connections via wired and/or wireless communications to one or more remote computers, such as a remote computer(s) 1450. The remote computer(s) 1450 can be a workstation, a server computer, a router, a personal computer, portable computer, microprocessor-based entertainment appliance, a peer device or other common network node, and typically includes many or all of the elements described relative to the computer 1402, although, for purposes of brevity, only a memory/storage device 1452 is illustrated. The logical connections depicted include wired/wireless connectivity to a local area network (LAN) 1454 and/or larger networks, e.g., a wide area network (WAN) 1456. Such LAN and WAN networking environments are commonplace in offices and companies, and facilitate enterprise-wide computer networks, such as intranets, all of which can connect to a global communications network, e.g., the Internet.

When used in a LAN networking environment, the computer 1402 can be connected to the local network 1454 through a wired and/or wireless communication network interface or adapter 1458. The adapter 1458 can facilitate wired or wireless communication to the LAN 1454, which can also include a wireless access point (AP) disposed thereon for communicating with the adapter 1458 in a wireless mode.

When used in a WAN networking environment, the computer 1402 can include a modem 1460 or can be connected to a communications server on the WAN 1456 via other means for establishing communications over the WAN 1456, such as by way of the Internet. The modem 1460, which can be internal or external and a wired or wireless device, can be connected to the system bus 1408 via the input device interface 1444. In a networked environment, program modules depicted relative to the computer 1402 or portions thereof, can be stored in the remote memory/storage device 1452. It will be appreciated that the network connections shown are examples, and other means of establishing a communications link between the computers can be used.

When used in either a LAN or WAN networking environment, the computer 1402 can access cloud storage systems or other network-based storage systems in addition to, or in place of, external storage devices 1416 as described above. Generally, a connection between the computer 1402 and a cloud storage system can be established over a LAN 1454 or WAN 1456 e.g., by the adapter 1458 or modem 1460, respectively. Upon connecting the computer 1402 to an associated cloud storage system, the external storage interface 1426 can, with the aid of the adapter 1458 and/or modem 1460, manage storage provided by the cloud storage system as it would other types of external storage. For instance, the external storage interface 1426 can be configured to provide access to cloud storage sources as if those sources were physically connected to the computer 1402.

The computer 1402 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

### Conclusion

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory in a single machine or multiple machines. Additionally, a processor can refer to an integrated circuit, a state machine, an application specific integrated circuit (ASIC), a digital signal processor (DSP), a programmable gate array (PGA) including a field programmable gate array (FPGA), a programmable logic controller (PLC), a complex programmable logic device (CPLD), a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units. One or more processors can be utilized in supporting a virtualized computing environment. The virtualized computing environment may support one or more virtual machines representing computers, servers, or other computing devices. In such virtualized virtual machines, components such as processors and storage devices may be virtualized or logically represented. For instance, when a processor executes instructions to perform “operations”, this could include the processor performing the operations directly and/or facilitating, directing, or cooperating with another device or component to perform the operations.

In the subject specification, terms such as “datastore,” data storage,” “database,” “cache,” and substantially any other information storage component relevant to operation and functionality of a component, refer to “memory components,” or entities embodied in a “memory” or components comprising the memory. It will be appreciated that the memory components, or computer-readable storage media, described herein can be either volatile memory or nonvolatile storage, or can include both volatile and nonvolatile storage. By way of illustration, and not limitation, nonvolatile storage can include ROM, programmable ROM (PROM), EPROM, EEPROM, or flash memory. Volatile memory can include RAM, which acts as external cache memory. By way of illustration and not limitation, RAM can be available in many forms such as synchronous RAM (SRAM), dynamic RAM (DRAM), synchronous DRAM (SDRAM), double data rate SDRAM (DDR SDRAM), enhanced SDRAM (ESDRAM), Synchlink DRAM (SLDRAM), and direct Rambus RAM (DRRAM). Additionally, the disclosed memory components of systems or methods herein are intended to comprise, without being limited to comprising, these and any other suitable types of memory.

The illustrated embodiments of the disclosure can be practiced in distributed computing environments where certain tasks are performed by remote processing devices that are linked through a communications network. In a distributed computing environment, program modules can be located in both local and remote memory storage devices.

The systems and processes described above can be embodied within hardware, such as a single integrated circuit (IC) chip, multiple ICs, an ASIC, or the like. Further, the order in which some or all of the process blocks appear in each process should not be deemed limiting. Rather, it should be understood that some of the process blocks can be executed in a variety of orders that are not all of which may be explicitly illustrated herein.

As used in this application, the terms “component,” “module,” “system,” “interface,” “cluster,” “server,” “node,” or the like are generally intended to refer to a computer-related entity, either hardware, a combination of hardware and software, software, or software in execution or an entity related to an operational machine with one or more specific functionalities. For example, a component can be, but is not limited to being, a process running on a processor, a processor, an object, an executable, a thread of execution, computer-executable instruction(s), a program, and/or a computer. By way of illustration, both an application running on a controller and the controller can be a component. One or more components may reside within a process and/or thread of execution and a component may be localized on one computer and/or distributed between two or more computers. As another example, an interface can include input/output (I/O) components as well as associated processor, application, and/or application programming interface (API) components.

Further, the various embodiments can be implemented as a method, apparatus, or article of manufacture using standard programming and/or engineering techniques to produce software, firmware, hardware, or any combination thereof to control a computer to implement one or more embodiments of the disclosed subject matter. An article of manufacture can encompass a computer program accessible from any computer-readable device or computer-readable storage/communications media. For example, computer readable storage media can include but are not limited to magnetic storage devices (e.g., hard disk, floppy disk, magnetic strips . . . ), optical discs (e.g., CD, DVD . . . ), smart cards, and flash memory devices (e.g., card, stick, key drive . . . ). Of course, those skilled in the art will recognize many modifications can be made to this configuration without departing from the scope or spirit of the various embodiments.

In addition, the word “example” or “exemplary” is used herein to mean serving as an example, instance, or illustration. Any embodiment or design described herein as “exemplary” is not necessarily to be construed as preferred or advantageous over other embodiments or designs. Rather, use of the word exemplary is intended to present concepts in a concrete fashion. As used in this application, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

What has been described above includes examples of the present specification. It is, of course, not possible to describe every conceivable combination of components or methods for purposes of describing the present specification, but one of ordinary skill in the art may recognize that many further combinations and permutations of the present specification are possible. Accordingly, the present specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
a processor; and
a memory coupled to the processor, comprising instructions that, in response to execution by the processor, cause the system to perform operations, comprising:
determining to combine a first function that executes in a first container and a second function that executes in a second container in a third container;
determining a first runtime of the first function based on a first container configuration of the first container;
determining a second runtime of the second function based on a second container configuration of the second container;
deploying the third container that comprises the first function matched to the first runtime and the second function matched to the second runtime;
directing a first call to the first function to the third container; and
directing a second call to the second function to the third container.

2. The system of claim 1, wherein a first type of the first runtime differs from a second type of the second runtime.

3. The system of claim 1, wherein the first runtime comprises a computer language in which the first function is written.

4. The system of claim 1, wherein the first runtime comprises a version of the computer language in which the first function is written.

5. The system of claim 1, wherein determining the first runtime of the first function based on the first container configuration of the first container comprises:
scanning a fusion configuration that corresponds to a fusion of the first function and the second function, wherein the first container configuration comprises the fusion configuration.

6. The system of claim 5, wherein determining the second runtime of the second function based on the second container configuration of the first container comprises:
scanning the fusion configuration that corresponds to the fusion of the first function and the second function, wherein the second container configuration comprises the fusion configuration.

7. The system of claim 1, wherein determining the first runtime of the first function based on the first container configuration of the first container comprises:
performing a code scan of a container configuration file of the first container configuration.

8. A method, comprising:
determining, by a system comprising a processor, to combine a first function that executes in a first container and a second function that executes in a second container in a third container;
determining, by the system, a first runtime of the first function based on a first container configuration of the first container, and a second runtime of the second function based on a second container configuration of the second container;
deploying, by the system, the third container that comprises the first function matched to the first runtime and the second function matched to the second runtime; and
directing, by the system, calls to the first function or to the second function to the third container.

9. The method of claim 8, further comprising:
in response to determining that language information of the first runtime is omitted from a fusion configuration that corresponds to a fusion of the first function and the second function,
performing, by the system, a code scan of a container configuration file of the first container configuration.

10. The method of claim 8, further comprising:
in response to determining that version information of the first runtime is omitted from a fusion configuration that corresponds to a fusion of the first function and the second function, performing, by the system, a code scan of a container configuration file of the first container configuration.

11. The method of claim 8, wherein determining to combine the first function that executes in the first container and the second function that executes in the second container is based on determining that the first function invokes the second function.

12. The method of claim 8, wherein deploying the third container comprises:
terminating the first container; and
terminating the second container.

13. The method of claim 8, wherein deploying the third container comprises:
accessing first source code of the first function and second source code of the second function from a repository;
packaging the first source code and the second source code into an image of the third container; and
deploying the image of the third container.

14. The method of claim 13, wherein the packaging and the deploying are performed by a continuous integration and continuous deployment component.

15. A non-transitory computer-readable medium comprising instructions that, in response to execution, cause a system comprising a processor to perform operations, comprising:
determining a first runtime of a first function that executes in a first container based on a first container configuration of the first container, and a second runtime of a second function that executes in a second container based on a second container configuration of the second container;
deploying a third container that comprises the first function matched to the first runtime and the second function matched to the second runtime; and
directing calls to the first function or to the second function to the third container.

16. The non-transitory computer-readable medium of claim 15, wherein the first runtime and the second runtime have different types.

17. The non-transitory computer-readable medium of claim 15, wherein the first runtime comprises a type of a computer language.

18. The non-transitory computer-readable medium of claim 15, wherein the first runtime comprises a version of a computer language.

19. The non-transitory computer-readable medium of claim 15, wherein determining the first runtime of the first function that executes in the first container based on the first container configuration of the first container comprises:
scanning a fusion configuration that corresponds to a fusion of the first function and the second function, wherein the first container configuration comprises the fusion configuration.

20. The non-transitory computer-readable medium of claim 19, wherein determining the second runtime of the second function that executes in the second container based on the second container configuration of the second container comprises:
scanning the fusion configuration that corresponds to the fusion of the first function and the second function, wherein the second container configuration comprises the fusion configuration.
